(19) United States
(12) Patent Application Publication
(10) Pub. No.: US 2018/0073976 A1
(43) Pub. Date: Mar. 15, 2018

(54) IMAGE-OBTAINING DEVICE AND IMAGE-OBTAINING METHOD

(71) Applicant: OLYMPUS CORPORATION, Tokyo (JP)

(72) Inventor: Kentaro IMOTO, Tokyo (JP)

(73) Assignee: OLYMPUS CORPORATION, Tokyo (JP)

(21) Appl. No.: 15/813,444

(22) Filed: Nov. 15, 2017

Related U.S. Application Data
(63) Continuation of application No. PCT/JP2016/065610, filed on May 26, 2016.
(60) Provisional application No. 62/183,227, filed on Jun. 23, 2015.

(51) Int. Cl. G01N 21/01; G01N 21/64; G02B 21/00

(52) U.S. Cl. CPC G01N 21/01; G01N 21/64; G02B 21/0032; G02B 21/0048; G01N 2201/06113; G01N 2201/10; G02B 21/0076

(57) ABSTRACT

Provided is an image-obtaining device including: an illumination-light generating unit that modulates an intensity of light emitted from a light source, and generates illumination light beams having mutually linearly independent patterns and including modulated illumination light and unmodulated illumination light; an illumination optical system that irradiates different positions on a sample with the illumination light beams generated; a light-detecting unit that detects combined signal light resulting from combining signal light beams generated at irradiation positions irradiated with the illumination light beams, and outputs a combined signal; and a demodulation unit that separates, from the combined signal output, a modulated local signal by using a time integral of a product of a demodulation signal corresponding to the modulated illumination light beam and the combined signal, and separates an unmodulated local signal by subtracting a sum of the modulated local signals from a time integral of the combined signal.

### CROSS-REFERENCE TO RELATED APPLICATIONS

This is a continuation of International Application PCT/JP2016/065610, with an international filing date of May 26, 2016, which is hereby incorporated by reference herein in its entirety. This application claims the benefit of U.S. Provisional Application No. 62/183,227, the content of which is incorporated herein by reference.

### TECHNICAL FIELD

The present invention relates to an image-obtaining device and an image-obtaining method.

### BACKGROUND ART

There is a known microscope that generates a plurality of illumination light beams having different irradiation patterns by using a DMD, and radiates the generated illumination light beams onto a plurality of different positions on a sample. The microscope restores fluorescence emitted from the respective irradiated positions, on the basis of the irradiation patterns given to the illumination light beams by the DMD, from fluorescence produced by combining fluorescence beams from a plurality of positions, which is detected by a detector (for example, refer to PTL 1).

### CITATION LIST

### Patent Literature

{PTL 1} PCT International Publication No. WO 2011/023593 Pamphlet

### SUMMARY OF INVENTION

An aspect of the present invention provides an image-obtaining device that simultaneously illuminates a plurality of regions, and separates and obtains local signals corresponding to the illuminated regions, the image-obtaining device including: an illumination-light generating unit that modulates an intensity of light emitted from a light source, and generates a plurality of illumination light beams having mutually linearly independent patterns and including modulated illumination light, which has been modulated, and unmodulated illumination light, which has not been modulated; an illumination optical system that irradiates different positions on a sample with the plurality of illumination light beams generated by the illumination-light generating unit; a light-detecting unit that detects combined signal light resulting from combining signal light beams generated at a plurality of irradiation positions irradiated with the illumination light beams by the illumination optical system, and outputs a combined signal; and a demodulation unit that separates, from the combined signal output by the light-detecting unit, a modulated local signal corresponding to the modulated illumination light beam by using a time integral of a product of a demodulation signal corresponding to the modulated illumination light beam and the combined signal, and separates therefrom an unmodulated local signal corresponding to the unmodulated illumination light beam by subtracting a sum of the modulated local signals from a time integral of the combined signal.

Another aspect of the present invention provides an image-obtaining method that includes: an illumination light generation step of modulating an intensity of light emitted from a light source, and generating a plurality of illumination light beams having mutually linearly independent patterns and including modulated illumination light, which has been modulated, and unmodulated illumination light, which has not been modulated; an irradiation step of irradiating different positions on a sample with the plurality of illumination light beams generated in the illumination light generation step; a light detection step of detecting combined signal light resulting from combining signal light beams generated at a plurality of irradiation positions irradiated with the illumination light beams in the irradiation step, and outputting a combined signal; and a signal light demodulation step of separating, from the combined signal output in the light detection step, a modulated local signal corresponding to the modulated illumination light beam by using a time integral of a product of a demodulation signal corresponding to the modulated illumination light beam and the combined signal, and separating therefrom an unmodulated local signal corresponding to the unmodulated illumination light beam by subtracting a sum of the modulated local signals from a time integral of the combined signal.

### BRIEF DESCRIPTION OF DRAWINGS

FIG. 1 is a schematic diagram illustrating an image-obtaining device according to an embodiment of the present invention.

FIG. 2A illustrates an example of a modulation signal of a pattern where modulation is performed by an electro-optical modulator in the image-obtaining device in FIG. 1.

FIG. 2B illustrates an example of a modulation signal of a pattern where modulation is not performed by the electro-optical modulator in the image-obtaining device in FIG. 1.

FIG. 2C illustrates an example of a demodulation signal for a pattern where modulation is performed by the electro-optical modulator in the image-obtaining device in FIG. 1.

FIG. 2D illustrates an example of a demodulation signal for a pattern where modulation is not performed by the electro-optical modulator in the image-obtaining device in FIG. 1.

FIG. 3 is a flowchart that describes an image-obtaining method according to an embodiment of the present invention.

FIG. 4 is a modification of the image-obtaining device in FIG. 1, and is a schematic diagram that illustrates an example in which the present invention is applied to a confocal microscope.

FIG. 5A is a modification of the image-obtaining device in FIG. 1 and illustrates another method of combining a plurality of illumination light beams.

FIG. 5B is a modification of the image-obtaining device in FIG. 1 and illustrates a method in which a pair of mirrors are arranged at positions within a broken line part S in FIG. 5A.

FIG. 6 is a modification of the image-obtaining device in FIG. 1 and illustrates another method of combining a plurality of illumination light beams.

FIG. 7 is a modification of the image-obtaining device in FIG. 1 and illustrates a method of adjusting the spacing between a plurality of illumination light beams.

FIG. 8 is a modification of the image-obtaining device in FIG. 1 and illustrates a case in which three illumination light beams are multiplexed.

FIG. 9A illustrates an example of a modulation signal of a first modulation pattern in the image-obtaining device in FIG. 8.

FIG. 9B illustrates an example of a modulation signal of a second modulation pattern in the image-obtaining device in FIG. 8.

FIG. 9C illustrates an example of a modulation signal of a pattern where modulation is not performed in the image-obtaining device in FIG. 8.

FIG. 9D illustrates an example of a demodulation signal for the first modulation pattern in the image-obtaining device in FIG. 8.

FIG. 9E illustrates an example of a demodulation signal for the second modulation pattern in the image-obtaining device in FIG. 8.

FIG. 9F illustrates an example of a demodulation signal for a pattern where modulation is not performed in the image-obtaining device in FIG. 8.

FIG. 10 is a modification of the image-obtaining device in FIG. 1 and illustrates a case in which modulation is performed using an acousto-optic deflection element.

FIG. 11 is a modification of the image-obtaining device in FIG. 1 and illustrates a case in which four illumination light beams are multiplexed using two acousto-optic deflection elements.

FIG. 12 is a modification of the image-obtaining device in FIG. 1 and illustrates a case in which four illumination light beams are multiplexed by effectively utilizing light that is removed when modulation is performed by the electro-optical modulator.

FIG. 13A is a pattern of light used in the image-obtaining device in FIG. 12, illustrating a pattern of a modulation signal for light from a light source.

FIG. 13B is a pattern of light used in the image-obtaining device in FIG. 12, illustrating a pattern of a modulation signal of a first illumination light beam immediately after being output from the electro-optical modulator.

FIG. 13C is a pattern of light used in the image-obtaining device in FIG. 12, illustrating a pattern of a modulation signal of a second illumination light beam immediately after being output from the electro-optical modulator.

FIG. 13D is a pattern of light used in the image-obtaining device in FIG. 12, illustrating a pattern of a modulation signal of a third illumination light beam immediately after being split off by a beam splitter.

FIG. 13E is a pattern of light used in the image-obtaining device in FIG. 12, illustrating a pattern of a modulation signal of a fourth illumination light beam immediately after being split off by the beam splitter.

FIG. 13F illustrates a pattern of light used in the image-obtaining device in FIG. 12, a pattern being a pattern of a demodulation signal for light from the light source.

FIG. 13G is a pattern of light used in the image-obtaining device in FIG. 12, illustrating a pattern of a demodulation signal for the first illumination light beam immediately after being output from the electro-optical modulator.

FIG. 13H is a pattern of light used in the image-obtaining device in FIG. 12, illustrating a pattern of a demodulation signal for the second illumination light beam immediately after being output from the electro-optical modulator.

FIG. 13I is a pattern of light used in the image-obtaining device in FIG. 12, illustrating a pattern of a demodulation signal for the third illumination light beam immediately after being split off by the beam splitter.

FIG. 13J is a pattern of light used in the image-obtaining device in FIG. 12, illustrating a pattern of a demodulation signal for the fourth illumination light beam immediately after being split off by the beam splitter.

FIG. 14A illustrates a pattern of a modulation signal of the first illumination light beam immediately after being combined by a beam splitter in the image-obtaining device in FIG. 12.

FIG. 14B illustrates a pattern of a modulation signal of the second illumination light beam immediately after being combined by the beam splitter in the image-obtaining device in FIG. 12.

FIG. 14C illustrates a pattern of a modulation signal of the third illumination light beam immediately after being combined by the beam splitter in the image-obtaining device in FIG. 12.

FIG. 14D illustrates a pattern of a modulation signal of the fourth illumination light beam immediately after being combined by the beam splitter in the image-obtaining device in FIG. 12.

FIG. 14E illustrates a pattern of a demodulation signal for the first illumination light beam immediately after being combined by the beam splitter in the image-obtaining device in FIG. 12.

FIG. 14F illustrates a pattern of a demodulation signal for the second illumination light beam immediately after being combined by the beam splitter in the image-obtaining device in FIG. 12.

FIG. 14G illustrates a pattern of a demodulation signal for the third illumination light beam immediately after being combined by the beam splitter in the image-obtaining device in FIG. 12.

FIG. 14H illustrates a pattern of a demodulation signal for the fourth illumination light beam immediately after being combined by the beam splitter in the image-obtaining device in FIG. 12.

FIG. 15 is a modification of the image-obtaining device in FIG. 1, illustrating a case in which four illumination light beams are multiplexed by effectively utilizing light that is removed when illumination light beams are combined using a beam splitter.

FIG. 16 is a schematic diagram that illustrates a case in which sheet illumination is utilized, which is a modification of the image-obtaining device in FIG. 1.

### DESCRIPTION OF EMBODIMENTS

Hereafter, an image-obtaining device 1 and an image-obtaining method according to an embodiment of the present invention will be described while referring to the drawings.

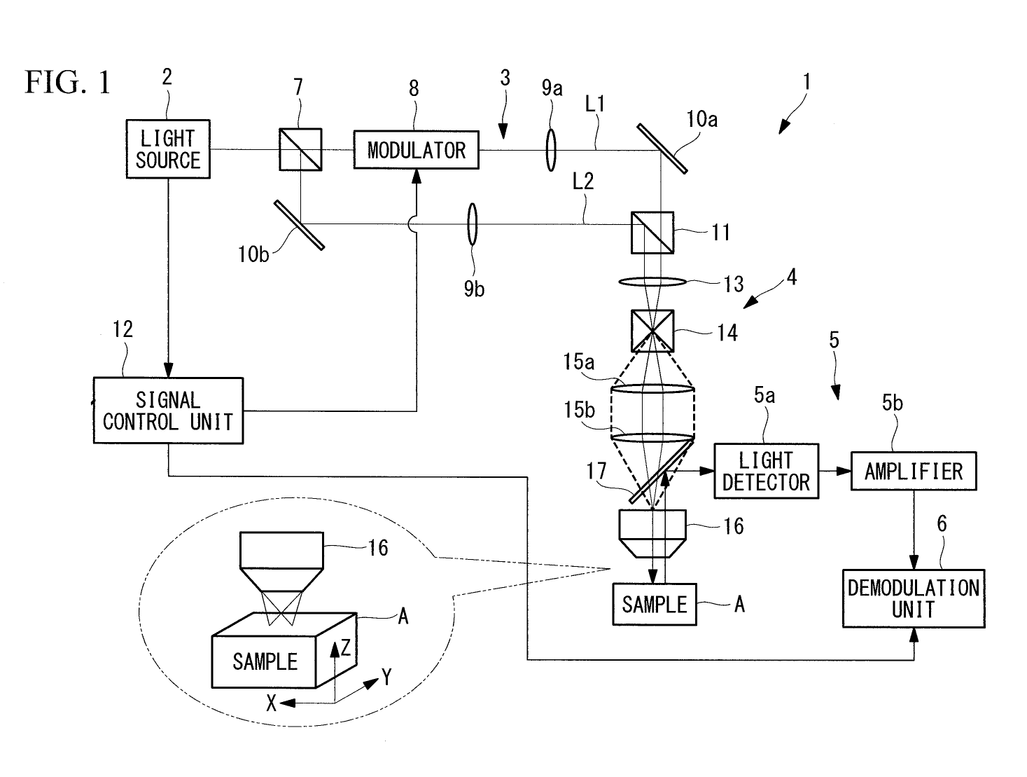

The image-obtaining device 1 according to this embodiment is a multi-photon-excitation-type scanning fluorescence microscope. As illustrated in FIG. 1, the image-obtaining device 1 includes: a light source 2 that emits, at prescribed time intervals, ultrashort-pulse laser light having a constant peak intensity; an illumination-light generating unit 3 that generates, from the light from the light source 2, two illumination light beams L1 and L2 that have mutually linearly independent patterns and that include modulated illumination light, which has been modulated, and unmodulated illumination light, which has not been modulated; an illumination optical system 4 that irradiates different positions on a sample A with the plurality of generated illumination light beams L1 and L2; a light-detecting unit 5 that detects combined fluorescence (combined signal light) constituted by fluorescence beams (signal light) generated at the plurality of positions irradiated with the illumination light beams L1 and L2, and outputs a combined signal; and a demodulation unit (signal light demodulation unit) 6 that demodulates the fluorescence beams generated at the respective irradiated positions from the output combined signal.

The illumination-light generating unit 3 includes: a first beam splitter (light-splitting unit) 7 that splits light from the light source 2 into two light paths; an electro-optical modulator (modulator) 8 that is provided along one of the split light paths, and modulates the pattern of changes in the light intensity of the light passing therethrough with respect to time; image-forming lenses 9a and 9b; mirrors 10a and 10b; and a second beam splitter (combining unit) 11 that combines the light beams of the two light paths. The mirror 10a is arranged at such a position as to shift a primary image forming position of the image-forming lens 9a, which is provided along the one light path, in a direction orthogonal to the optical axis with respect to a primary image forming position of the image-forming lens 9b, which is provided along the other light path.

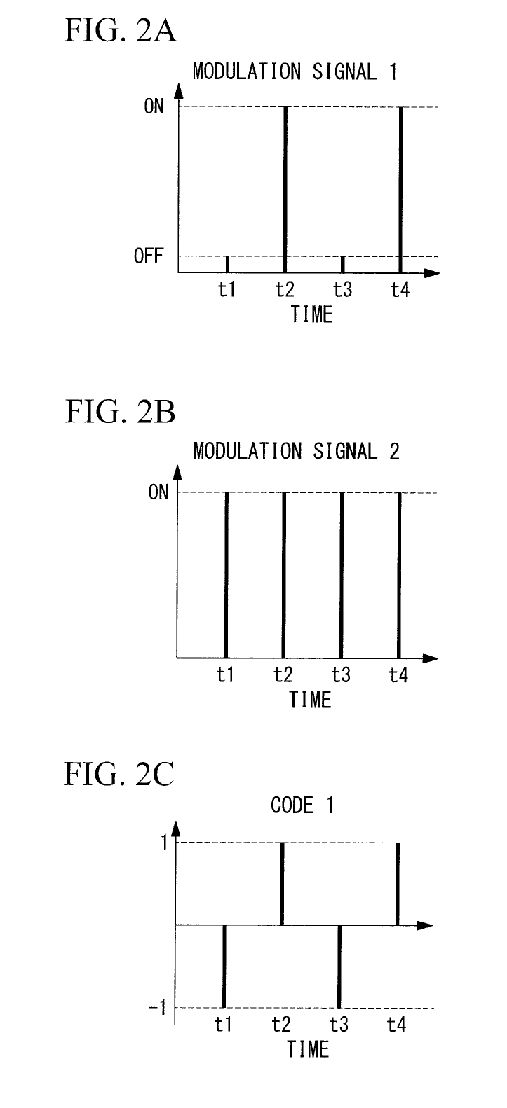

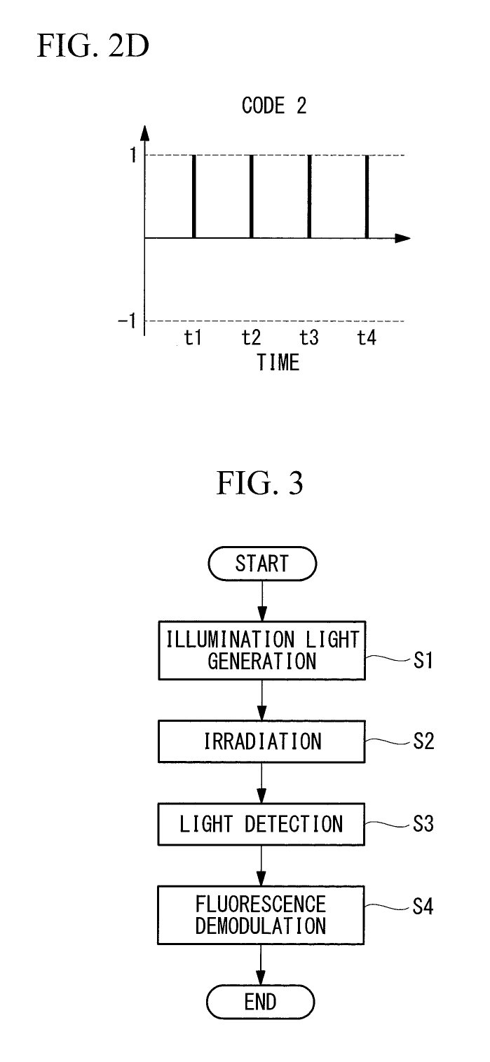

A signal control unit 12 is connected to the electro-optical modulator 8. The signal control unit 12 transmits a modulation signal, such as that illustrated in FIG. 2A, to the electro-optical modulator 8, and thereby causes modulation to be performed with a duty of 50% by removing every other pulse of light from the light source. For example, in the case where the light emitted from the light source 2 has a repetition frequency of 80 MHz, the electro-optical modulator 8 generates an illumination light beam L1 of 40 MHz by modulating the intensity of the light from the light source 2. Thus, the illumination light beam L1 output from the electro-optical modulator 8 has a modulation pattern in which the intensity changes at 40 MHz.

In addition, the electro-optical modulator 8 is not provided along the other light path, and the illumination light beam L2 is generated so as to have a pattern in which the light emitted from the light source 2 is unchanged, that is, an unmodulated pattern made up of a string of pulses having a constant peak intensity.

Thus, the modulated-pattern illumination light beam L1 and the unmodulated-pattern illumination light beam L2 that pass along the two light paths have intensities that change with respect to time with mutually linearly independent patterns.

The illumination optical system 4 includes: a pupil projection lens 13 that projects the two illumination light beams L1 and L2 combined by the second beam splitter 11 onto a scanner 14; the scanner 14, which simultaneously two-dimensionally scans the two illumination light beams L1 and L2 in the same directions (XY directions); relay lenses 15a and 15b that relay the illumination light beams L1 and L2 that have been scanned by the scanner 14; and an objective lens 16 that irradiates a plurality of irradiation positions on the sample A with the illumination light beams L1 and L2 relayed by the relay lenses 15a and 15b, and that collects fluorescence beams generated at the respective irradiation positions on the sample A. The scanner 14 is a galvanometer mirror, for example.

The scanner 14 and the pupil position of the objective lens 16 are arranged at optically conjugate positions. In addition, the inter-lens distances between the image-forming lenses 9a and 9b and the pupil projection lens 13 are set so as to be equal to each other along the two light paths.

A dichroic mirror 17, which has characteristics of transmitting the illumination light beams L1 and L2 therethrough and reflecting fluorescence, is arranged between the relay lenses 15a and 15b and the objective lens 16 of the illumination optical system 4. The light-detecting unit 5 includes, for example, a light detector 5a such as a photomultiplier tube, and an amplifier 5b that amplifies an intensity signal of fluorescence detected by the light detector 5a.

The demodulation unit 6 receives, from the signal control unit 12, a demodulation signal that is synchronized with the modulation signal and demodulates the fluorescence beams generated at the respective irradiation positions from the combined fluorescence detected by the light detector 5a. Specifically, a modulated local signal corresponding to the modulated illumination light beam is separated by using the time integral of the product of the demodulation signal corresponding to the modulated illumination light beam and the combined signal, and an unmodulated local signal corresponding to the unmodulated illumination light beam is separated by subtracting the sum of the modulated local signals from the time integral of the combined signal. In this case, the time integral of the product of a demodulation signal that does not correspond to the modulated illumination light beam, a modulated local signal that does not correspond to the modulated illumination light beam, and an unmodulated local signal is zero, and the time integral of the product of a demodulation code corresponding to the unmodulated illumination light signal and the combined signal is the time integral of the combined signal.

In this example, the demodulation signal is synchronized with the ON/OFF states of modulation, and is 1 when ON and −1 when OFF. In the above-described example, the demodulation signal illustrated in FIG. 2C, which is synchronized with the modulation signal illustrated in FIG. 2A that is for generating the illumination light beam L1 having a modulation pattern obtained by modulating the intensity of the light from the light source 2, can be represented as code 1=(−1, 1, −1, 1). On the other hand, a demodulation signal for the case where modulation is not performed, as illustrated in FIG. 2B, can be represented as code 2=(1, 1, 1, 1), as illustrated in FIG. 2D. The length of each code corresponds to the light exposure period of one pixel. In this example, although the codes and light modulation correspond to individual pulses, modulation may instead be performed on every string of pulses of an arbitrary length.

In the demodulation unit 6, the intensity of fluorescence having a modulation pattern is demodulated by separating a modulated local signal corresponding to the modulated illumination light beam by multiplying the intensity of the combined fluorescence detected by the light detector 5a by the demodulation signal code 1 that is synchronized with the modulation timing, and integrating the result of this multiplication over the light exposure period. On the other hand, the intensity of fluorescence having an unmodulated pattern is demodulated by separating an unmodulated local signal corresponding to the unmodulated illumination light beam by subtracting the demodulated intensity of fluorescence having a modulation pattern (sum of modulated local signals) from the integral value of the combined fluorescence obtained by integrating the intensity of the combined fluorescence detected by the light detector 5a over the light exposure period. Since multiplying by the demodulation signal code 2 is equivalent to not multiplying by anything, the intensity of fluorescence having the modulation pattern is simply subtracted from the integral value of the detected combined fluorescence.

As a specific example, a represents a fluorescence signal intensity corresponding to one pulse of the illumination light beam L1, and β represents a fluorescence signal corresponding to one pulse of the illumination light beam L2.

In addition, taking the light exposure period to be four pulses, time-series data D1 of a fluorescence signal during the light exposure period corresponding to the illumination light beam L1 is (0, α, 0, α). On the other hand, time-series data D2 of a fluorescence signal during the light exposure period corresponding to the illumination light beam L2 is (β, β, β, β). Therefore, time-series data D of the combined fluorescence signal is D=D1+D2=(β, α+β, β, α+β).

Taking the inner product of the time-series data D of the combined fluorescence signal and code 1 (equivalent to calculating the product and then integrating the result), 2α corresponding to the integral value of D1 can be calculated. Furthermore, the inner product of the time-series data D of the combined fluorescence signal and code 2 is the integral value 2α+4β of the combined fluorescence signal, and a fluorescence signal 4β corresponding to the illumination light beam L2 can be obtained by subtracting the already obtained fluorescence signal intensity 2α corresponding to the illumination light beam L1 from the integral value 2α+4β of the combined fluorescence signal.

Next, an image-obtaining method in which the thus-configured image-obtaining device 1 according to this embodiment is used will be described.

As illustrated in FIG. 3, the image-obtaining method according to this embodiment includes: an illumination light generation step S1 of generating the plurality of illumination light beams L1 and L2 that have mutually linearly independent patterns from the ultrashort-pulse laser light emitted from the light source 2; an irradiation step S2 of irradiating different positions on the sample A with the generated plurality of illumination light beams L1 and L2; a light detection step S3 of detecting combined fluorescence that results from combining fluorescence beams generated at the plurality of irradiation positions irradiated by the illumination light beams L1 and L2; and a fluorescence demodulation step (signal light demodulation step) S4 of demodulating, from the detected combined fluorescence, the fluorescence beams generated at the respective irradiation positions by using demodulation signals that are synchronized with the illumination light beams L1 and L2.

With the thus-configured image-obtaining device 1 and image-obtaining method according to this embodiment, since it is sufficient to provide the electro-optical modulator 8 along one of the two split light paths, the two illumination light beams L1 and L2 can be multiplexed with just one electro-optical modulator 8, and there is an advantage in that the device can be simplified, and a reduction in cost can be realized.

The sample A is simultaneously irradiated with the two multiplexed illumination light beams L1 and L2, and therefore two different regions of the sample can be simultaneously imaged by scanning the spots of the two illumination light beams L1 and L2 over the sample A using the scanner 14, and as a result, the frame rate at which an image of the observation region is obtained can be doubled without the need for multiple devices corresponding to the number of times multiplexing is performed.

In addition, since modulation does not have to be performed on the illumination light beam L2 that passes along one light path, there is an advantage in that the obtained signal strength is improved 1.5 fold at maximum compared with the case where two illumination light beams L1 and L2 are generated using two electro-optical modulators.

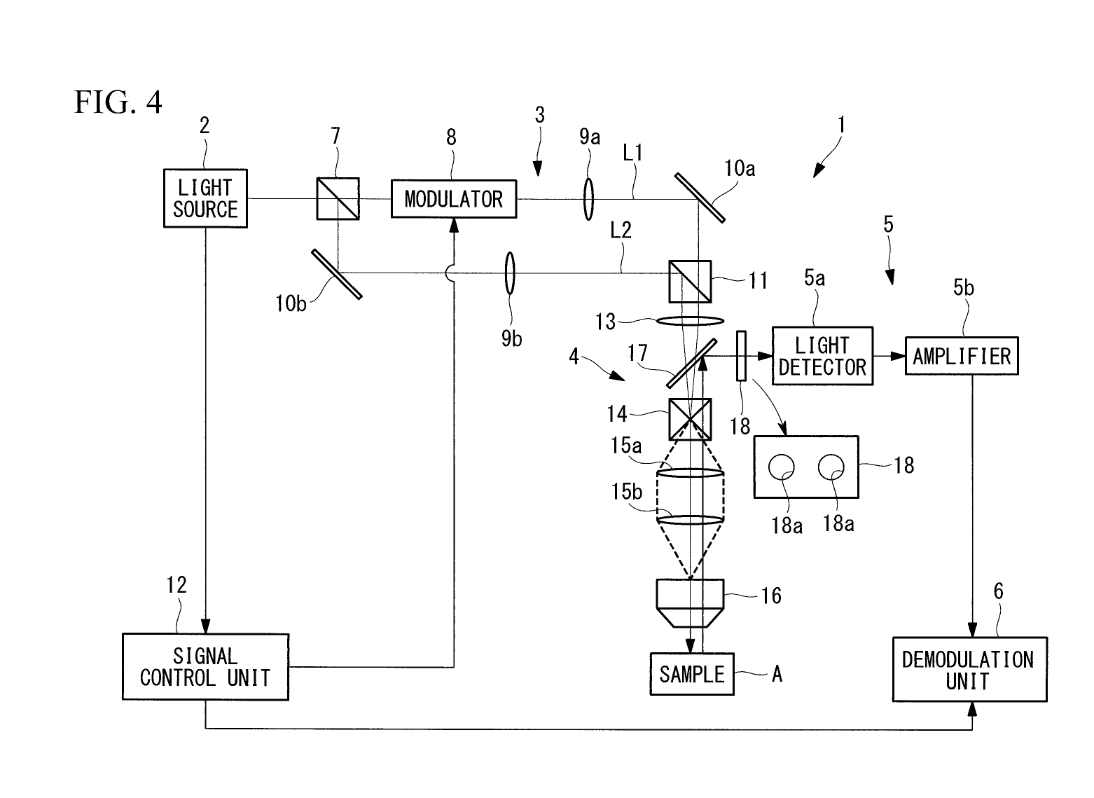

In addition, a multi-photon-excitation-type fluorescence microscope is exemplified as the image-obtaining device 1 in this embodiment, and therefore the dichroic mirror 17 that splits fluorescence from the illumination light beams L1 and L2 is arranged between the objective lens 16 and the relay lens 15b, but the present invention may instead be applied to a confocal microscope, and the dichroic mirror 17 may be arranged closer to the light source 2 than the scanner 14, and a pinhole member 18 may be arranged at a position that is optically conjugate with the focal positions of the illumination light beams L1 and L2 realized by the objective lens 16, as illustrated in FIG. 4.

The number of through holes 18a and the spacing of the through holes 18a in the pinhole member 18 are set in accordance with the number of illumination light beams L1 and L2 and the distance between the focal positions of the illumination light beams L1 and L2.

In addition, in this case, it is sufficient to employ a light source that emits continuous light having a constant intensity as the light source 2.

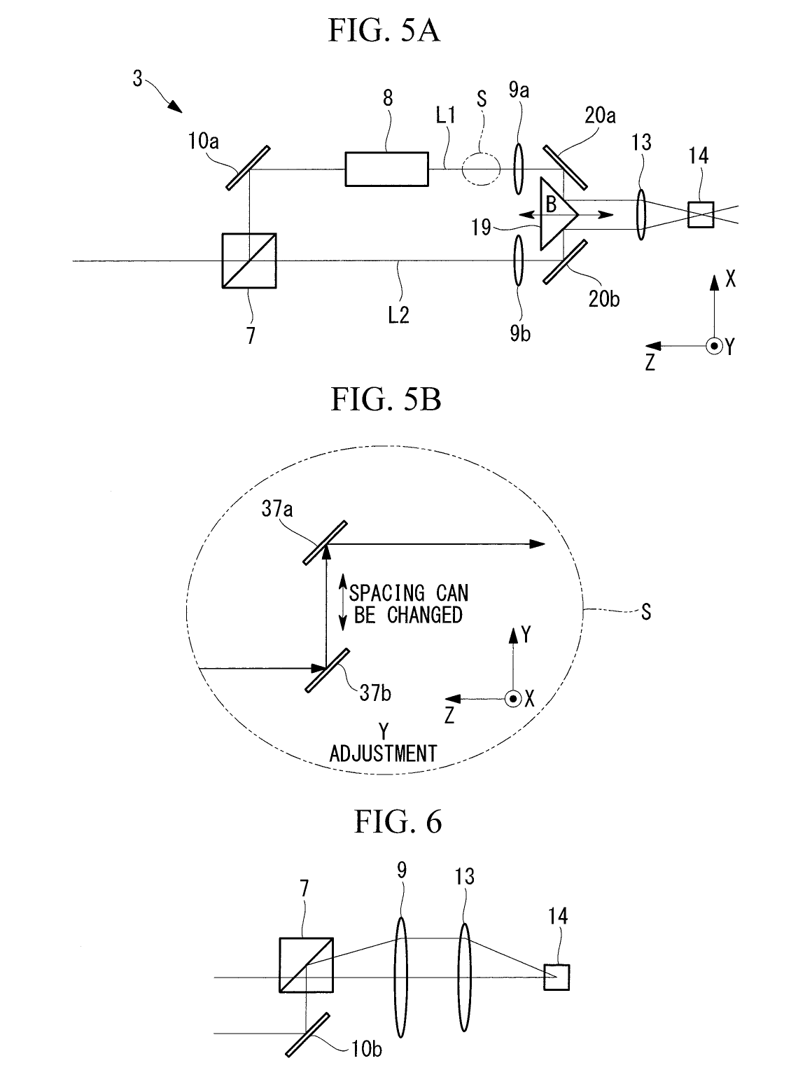

Furthermore, although a beam splitter is employed as the light-splitting unit 7, a polarization beam splitter may instead be employed. In addition, although a beam splitter is employed, a polarization beam splitter or a combination of a triangular prism 19 and mirrors 20a and 20b may instead be employed as the combining unit 11, as illustrated in FIG. 5A. In this case, when the triangular prism 19 and the mirrors 20a and 20b are moved relative to each other in the directions indicated by the arrow B, the spacing between the illumination light beams L1 and L2 in the X direction can be changed.

Furthermore, instead of being combined at a point between the image-forming lenses 9a and 9b and the pupil projection lens 13, the light beams may instead be combined at a point closer to the light source 2 than the image-forming lens 9, and a single image-forming lens 9 may be employed, as illustrated in FIG. 6. In addition, splitting and combining of light may be performed using any other method.

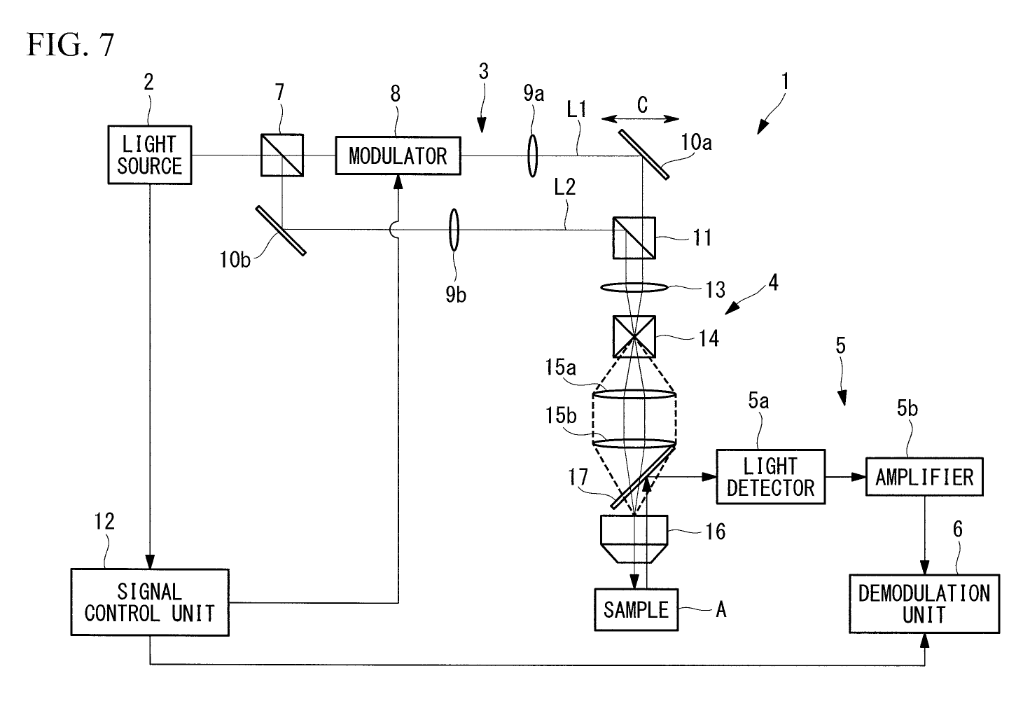

Furthermore, although the shift amount of the primary image forming position is fixed as a result of the mirror 10a being fixed, the shift amount of the primary image forming position may be made adjustable by moving the mirror 10a in the directions indicated by the arrow C illustrated in FIG. 7.

In addition, although the electro-optical modulator 8 is exemplified as the modulator, a modulator such as an acousto-optic modulator may instead be employed.

Furthermore, as illustrated in FIG. 5B, in addition to the combination of the triangular prism 19 and the mirrors 20a and 20b, a pair of mirrors 37a and 37b that enable the spacing between the illumination light beams L1 and L2 in the Y direction to be changed may be introduced along the light path in order to allow the light beam height of the illumination light beam L1 to be changed. Thus, the beam can be shifted in the Y direction (direction orthogonal to the adjacent beam) in a plane orthogonal to the optical axis by decreasing or increasing the spacing between the mirrors 37a and 37b.

In addition, the Z direction positions of the focal points on the sample A may be adjusted by providing the lenses 9a and 9b along the optical axes such that the lenses 9a and 9b can be moved, and moving the lenses 9a and 9b along the optical axes.

With this configuration, the focal points can be arranged at any arbitrary positions by using a combination of movement in the XY directions orthogonal to the optical axes and movement in the Z direction along the optical axes. Thus, imaging of arbitrary separated volumes can be performed simultaneously. As a result, the interactions between regions having different functions can be elucidated by using simultaneous imaging of a plurality of regions such as in elucidation of the functions of the brain.

Furthermore, although the light from the light source 2 is split into two beams in this embodiment, the light may instead be split into three or more beams. The number of pulses that have arrived can be thought of in the same way as the dimensions of vector space used in demodulation, and therefore, multiplexing of illumination light can be performed the same number of times as the number of pulses that arrive during the light exposure period. Thus, a further improvement in speed can be achieved.

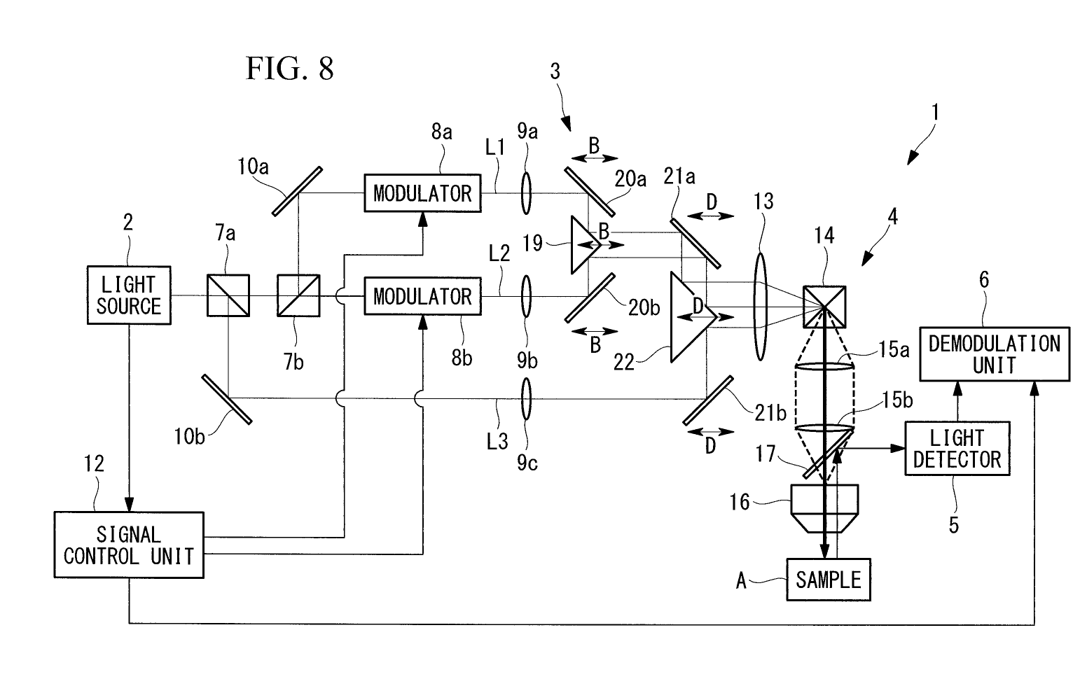

FIG. 8 exemplifies a case in which light is split into three light paths.

Splitting of the light into three light paths is realized by a beam splitter 7a that splits light from the light source 2 into a light path for illumination light beams L1 and L2 and a light path for an illumination light beam L3, and a beam splitter 7b that is arranged downstream of the beam splitter 7a and further splits the split light path for the illumination light beams L1 and L2 into a light path for the illumination light beam L1 and a light path for the illumination light beam L2. Image-forming lenses 9a, 9b and 9c are respectively arranged along the three light paths.

There is no electro-optical modulator 8 along one light path, but electro-optical modulators (modulators) 8a and 8b that generate the illumination light beams (modulated illumination light beams) L1 and L2 having modulation patterns that are orthogonal to each other are respectively arranged along the other two light paths.

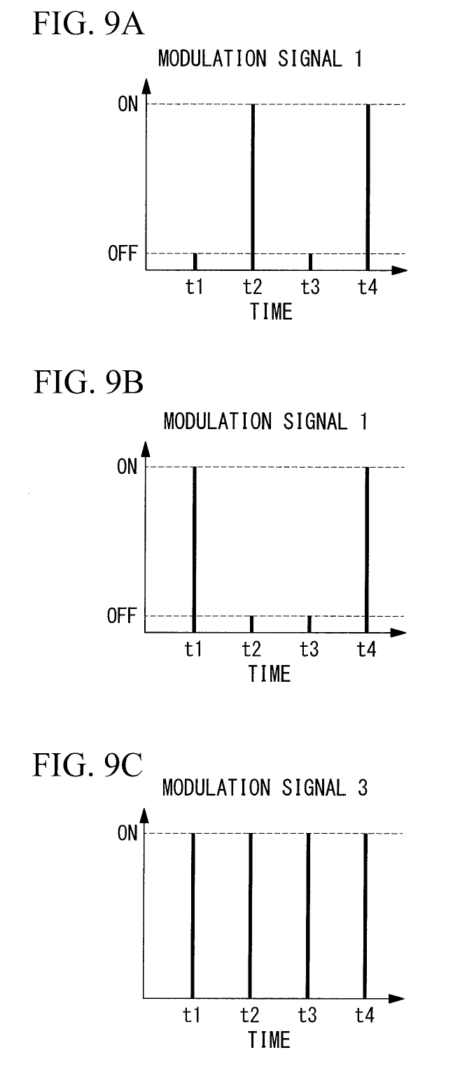

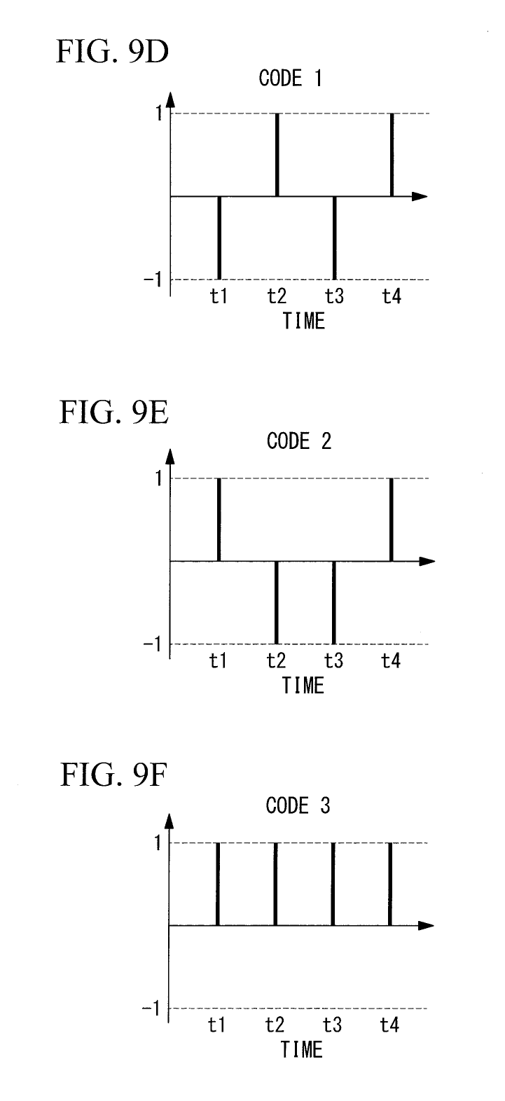

Specifically, a modulation signal that corresponds to one electro-optical modulator 8a and a demodulation signal code 1=(−1, 1, −1, 1) for the modulation pattern, as illustrated in FIGS. 9A and 9D, a modulation signal corresponding to the other electro-optical modulator 8b and a demodulation signal code 2=(1, −1, −1, 1) for the modulation pattern, as illustrated in FIGS. 9B and 9E, and a modulation signal for the case where modulation is not performed by the electro-optical modulators 8a and 8b and a demodulation signal code 3=(1, 1, 1, 1) for the modulation pattern, as illustrated in FIGS. 9C and 9F, are employed.

α represents a fluorescence signal corresponding to one pulse of the illumination light beam L1, β represents a fluorescence signal corresponding to one pulse of the illumination light beam L2, and γ represents a fluorescence signal corresponding to one pulse of the illumination light beam L3.

In addition, taking the light exposure period to be four pulses, time-series data D1 of a fluorescence signal during the light exposure period corresponding to the illumination light beam L1 is (0, α, 0, α). Time-series data D2 of a fluorescence signal during the light exposure period corresponding to the illumination light beam L2 is (β, 0, 0, β), and time-series data D3 of a fluorescence signal during the light exposure period corresponding to the illumination light beam L3 is (γ, γ, γ, γ). Therefore, time-series data D of the combined fluorescence signal is D=D1+D2+D3=(β+γ, α+γ, γ, α+β+γ).

When the inner product of the time-series data D of the combined fluorescence signal and code 1 is obtained, 2α corresponding to the integral value of D1 can be calculated, and when the inner product of the time-series data D of the combined fluorescence signal and code 2 is obtained, 2β corresponding to the integral value of D2 can be calculated. In addition, the inner product of the time-series data D of the combined fluorescence signal and code 3 is the integral value 2α+2β+4γ of the combined fluorescence signal, and the fluorescence signal 4γ corresponding to the illumination light beam L3 can be obtained by subtracting the already obtained fluorescence signal intensity 2α corresponding to the illumination light beam L1 and the fluorescence signal intensity 2β corresponding to the illumination light beam L2 from the integral value 2α+2β+4γ of the combined fluorescence signal.

The fluorescence corresponding to the illumination light beam L1 of the first modulation pattern can be demodulated by multiplying the intensity of the detected combined fluorescence by the demodulation signal code 1 that is synchronized with the modulation and integrating the result of the multiplication. In addition, the fluorescence corresponding to the illumination light beam L2 of the second modulation pattern can be demodulated by multiplying the intensity of the detected combined fluorescence by the demodulation signal code 2 that is synchronized with the timing of the modulation and integrating the result of the multiplication. The fluorescence corresponding to the illumination light beam L3 of the pattern where modulation has not been performed can be demodulated by subtracting the fluorescence intensities corresponding to the first and second modulation patterns from the integral value of the intensity of the detected combined fluorescence.

Combining of the illumination light beams L1 and L2 having the two modulation patterns, and combining of the combined illumination light beams L1 and L2 having the modulation patterns and the illumination light beam L3 having an unmodulated pattern are performed using a combination of mirrors 21a and 21b and a triangular prism 22. Thus, three or more illumination light beams L1, L2, and L3 can be efficiently combined. In this case, the spacing between the illumination light beams L1, L2, and L3 can be changed by moving the mirrors 21a and 21b and the triangular prism 22 relative to each other in the directions indicated by arrow D.

In addition, modulation patterns for which the demodulation Codes corresponding to the illumination light beams L1 and L2 are mutually orthogonal have been described for the case where the light is split into three light paths, but the present invention is not limited to this example, and modulation patterns for which the demodulation Codes corresponding to the illumination light beams L1 and L2 are not orthogonal to each other may instead be employed.

Specifically, a demodulation signal code 1 for the modulation pattern corresponding to one electro-optical modulator 8a is (1, 0, 0, −1), a demodulation signal code 2 for the modulation pattern corresponding to the other electro-optical modulator 8b is (0, 1, 0, −1), and a demodulation signal code 3 for a pattern where modulation is not performed by the electro-optical modulators 8a and 8b is (1, 1, 1, 1). In this case, optical modulation corresponding to 0 means OFF.

α represents a fluorescence signal corresponding to one pulse of the illumination light beam L1, β represents a fluorescence signal corresponding to one pulse of the illumination light beam L2, and γ represents a fluorescence signal corresponding to one pulse of the illumination light beam L3.

In addition, taking the light exposure period to be four pulses, time-series data D1 of a fluorescence signal during the light exposure period corresponding to the illumination light beam L1 is (α, 0, 0, 0). Time-series data D2 of a fluorescence signal during the light exposure period corresponding to the illumination light beam L2 is (0, β, 0, 0), and time-series data D3 of a fluorescence signal during the light exposure period corresponding to the illumination light beam L3 is (γ, γ, γ, γ). Therefore, time-series data D of the combined fluorescence signal is D=D1+D2+D3=(α+γ, β+γ, γ, γ).

When the inner product of the time-series data D of the combined fluorescence signal and code 1 is obtained, α corresponding to the integral value of D1 can be calculated, and when the inner product of the time-series data D of the combined fluorescence signal and code 2 is obtained, β corresponding to the integral value of D2 can be calculated. In addition, the inner product of the time-series data D of the combined fluorescence signal and code 3 is the integral value α+β+4γ of the combined fluorescence signal, and the fluorescence signal 4γ corresponding to the illumination light beam L3 can be obtained by subtracting the already obtained fluorescence signal intensity a corresponding to the illumination light beam L1 and the fluorescence signal intensity β corresponding to the illumination light beam L2 from the integral value α+β+4γ of the combined fluorescence signal.

Furthermore, in this embodiment, a resonance electro-optical modulator (not illustrated) may be employed instead of the electro-optical modulator 8. In the case of a resonance electro-optical modulator, driving can be performed at a lower voltage, and therefore, there is an advantage in that a cost reduction can be realized since a power amplifier is not necessary. An arbitrary pattern can be generated during the light exposure period by making the resonance period of the resonance electro-optical modulator be the same as the repetition period.

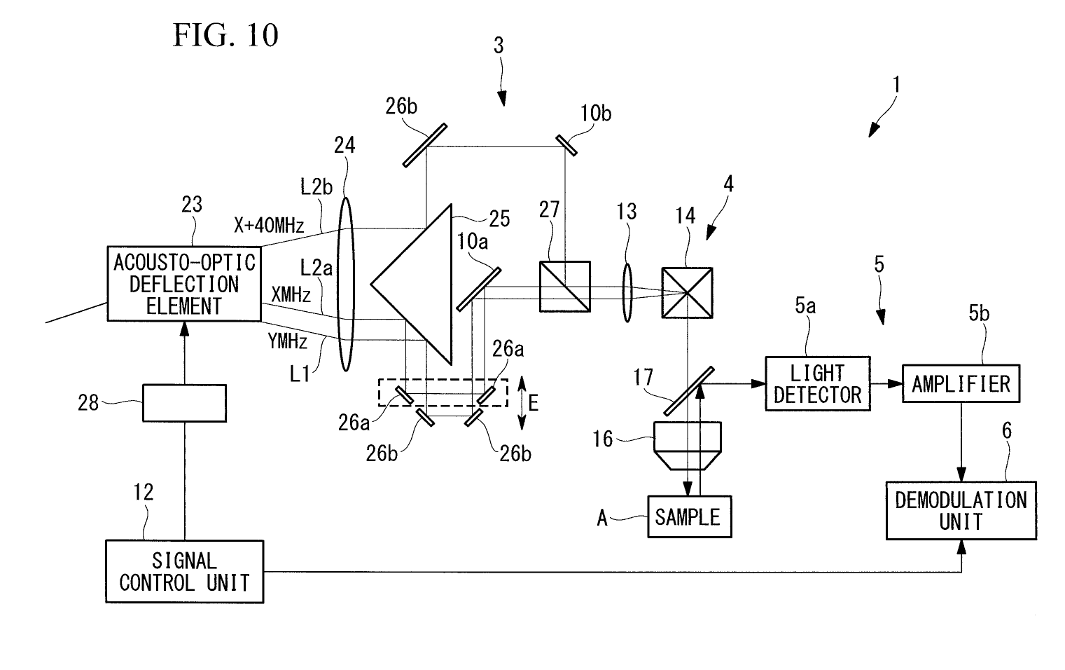

In addition, although the intensity of the light in one light path is modulated by the electro-optical modulator 8, instead of this, the frequency of light may be modulated to a beat frequency using interference between light beams of different frequencies using a combination of an acousto-optic deflection element 23, a lens 24, a prism 25, mirrors 26a and 26b, and a beam splitter 27, as illustrated in FIG. 10.

For example, in the example illustrated in FIG. 10, a light beam L1 that is not frequency modulated (unmodulated pattern of light source frequency Y MHz), a light beam L2a that has been frequency modulated to a frequency X MHz (first modulation pattern), and a light beam L2b that has been frequency modulated to frequency X+40 MHz (second modulation pattern) are generated by the acousto-optic deflection element 23. The generated light beams L2a and L2b of the first and second modulation patterns are guided along different light paths having the same optical path length via the lens 24, the prism 25 and the mirrors 26a and 26b, are then combined by the beam splitter 27, and consequently interfere with each other, and as a result form an illumination light beam L2 having a frequency equal to the frequency difference between the light beams L2a and L2b (40 MHz). The mirrors 26a are provided so as to be movable in the directions indicated by arrow E in order to adjust the optical path length.

Thus, different positions on the sample A can be irradiated with the illumination light beam L1 having an unmodulated pattern of frequency Y MHz and the illumination light beam L2 having a modulation pattern of a frequency of 40 MHz.

In this configuration, the signal control unit 12 can arbitrarily adjust the frequencies of the light beams L2a and L2b of the two modulation patterns by controlling a driver 28 of the acousto-optic deflection element 23, and can arbitrarily adjust the irradiation position of the illumination light beam L2 on the sample A through electrical control of the acousto-optic deflection element 23 utilizing the fact that the irradiation direction differs depending on the frequency.

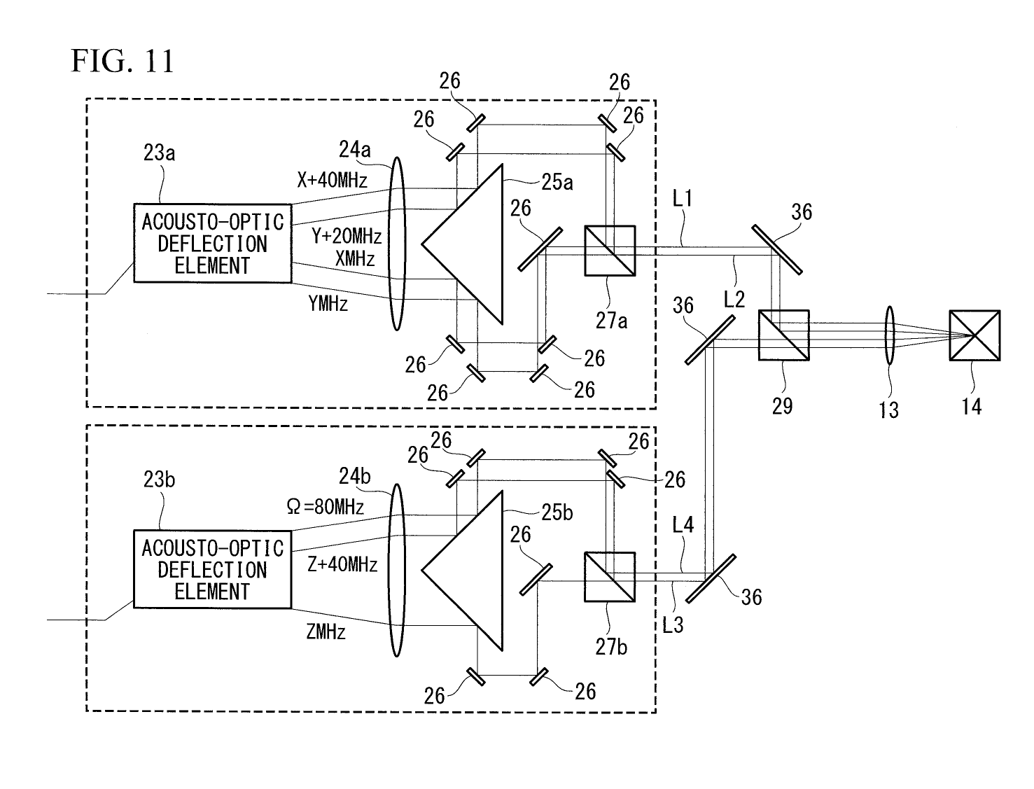

In addition, as illustrated in FIG. 11, a total of four illumination light beams consisting of illumination light beams L1, L2, and L3 of three different modulation patterns and an illumination light beam L4 of an unmodulated pattern may be simultaneously radiated onto the sample A.

For example, in the example illustrated in FIG. 11, two sets of equipment consisting of acousto-optic deflection elements 23a and 23b, lenses 24a and 24b, prisms 25a and 25b, mirrors 26, and beam splitters 27a and 27b are utilized.

In the light coming from the light source 2, light of one polarization direction, for example, P-polarized light, is incident on one acousto-optic deflection element 23a. The acousto-optic deflection element 23a splits the incident light into four light beams of X MHz, Y MHz, X+20 MHz, and Y+20 MHz. The split light beams pass through the lens 24a, the prism 25a, and the mirrors 26, and as a result, the light beam of X MHz, the light beam of X+20 MHz, the light beam of Y MHz, and the light beam of Y+20 MHz are combined with each other and are made to interfere with each other by the beam splitter 27a. Thus, two illumination light beams L1 and L2 having a beat frequency of 20 MHz are generated. The phases of the two illumination light beams L1 and L2 at the beat frequency are shifted by 90□ by adjusting the phase of a driving voltage waveform input to the driver 28 of the acousto-optic deflection element 23a. Thus, mutually orthogonal patterns can be generated.

In the light coming from the light source 2, light of another polarization direction, for example, S-polarized light, is incident on the other acousto-optic deflection element 23b. The acousto-optic deflection element 23b splits the incident light into three light beams of Ω=80 MHz, Z+40 MHz, and Z MHz. The split light beams pass through the lens 24b, the prism 25b, and the mirrors 26, and as a result, the light beam of Z+40 MHz and the light beam of Z MHz are combined with each other and are made to interfere with each other by the beam splitter 27b. Thus, an illumination light beam L3 having a beat frequency of 40 MHz is generated. The light beam of Ω MHz is guided unchanged to the beam splitter 27b via the lens 24b, the prism 25b, and the mirrors 26, and becomes the illumination light L4 having an unmodulated pattern.

The four illumination light beams L1 to L4 pass through the mirrors 36, are combined with each other by a polarization beam splitter 29, and are radiated onto different positions on the sample A.

As a result, the four illumination light beams L1 to L4 are multiplexed and radiated onto the sample A, and there is an advantage in that a further improvement in frame rate can be achieved.

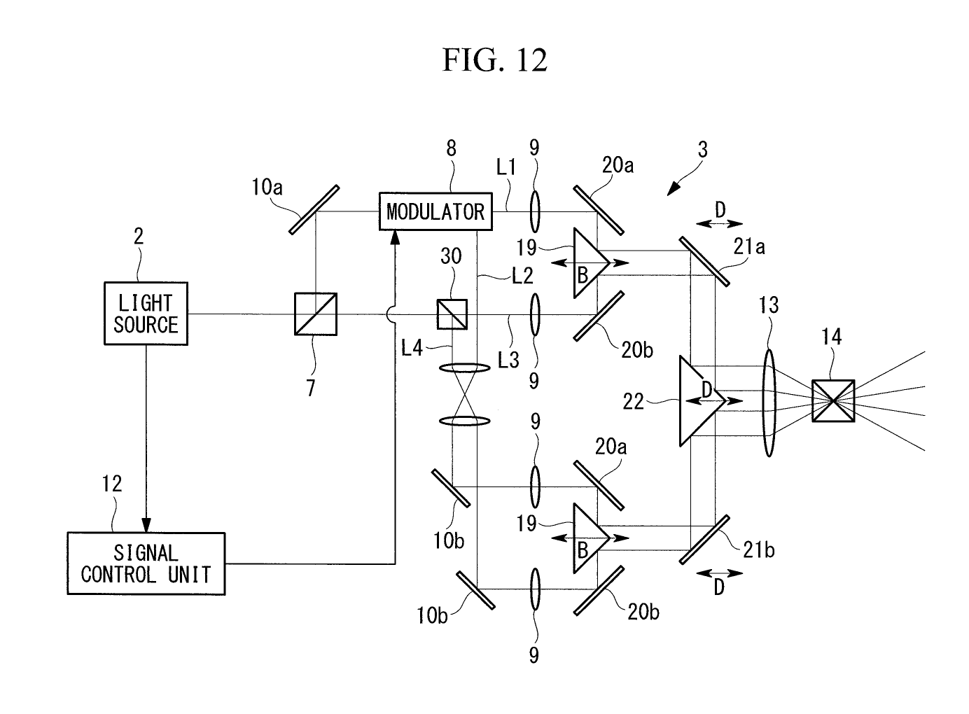

Furthermore, as illustrated in FIG. 12, light cut off by a polarization element among electro-optical elements may be utilized and multiplexed when light may be modulated at a duty of 50% by the electro-optical modulator 8.

That is, two illumination light beams L1 and L2 having inverted phases are emitted from the electro-optical modulator 8, and therefore, illumination light beams L1 and L2 having different detection timings from each other can be generated by adjusting the optical path length of one illumination light beam L2 to realize a time delay of half the oscillation period of the laser light. In addition, illumination light beams L3 and L4 having different detection timings from each other can be generated by arranging a beam splitter 30 along the light path not equipped with the electro-optical modulator 8 in order to split the light and realizing a time delay of half the oscillation period of the laser light by adjusting the light path length of the split off light.

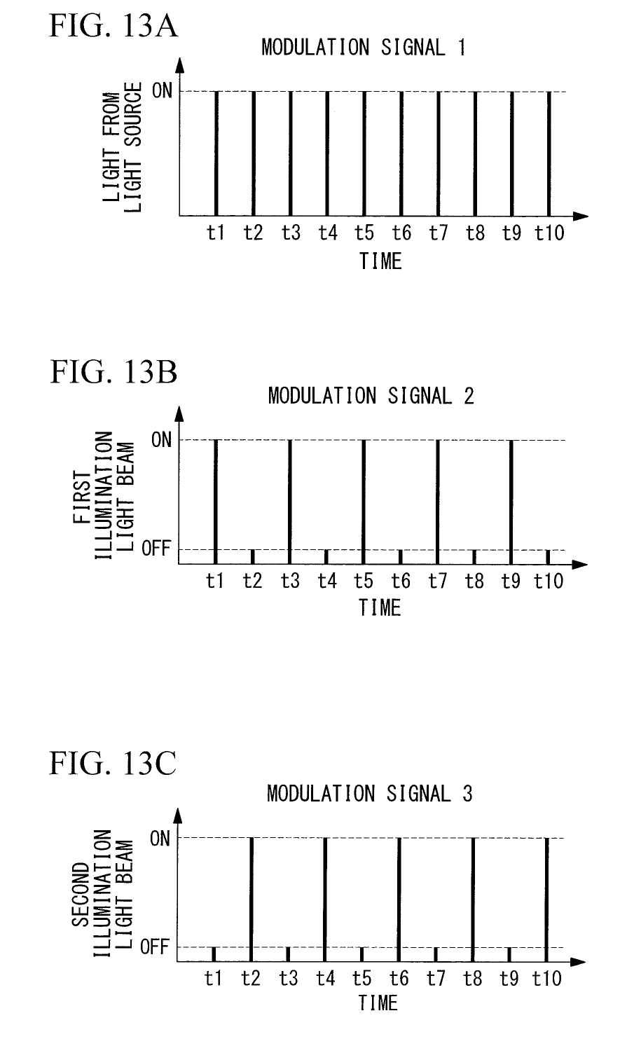

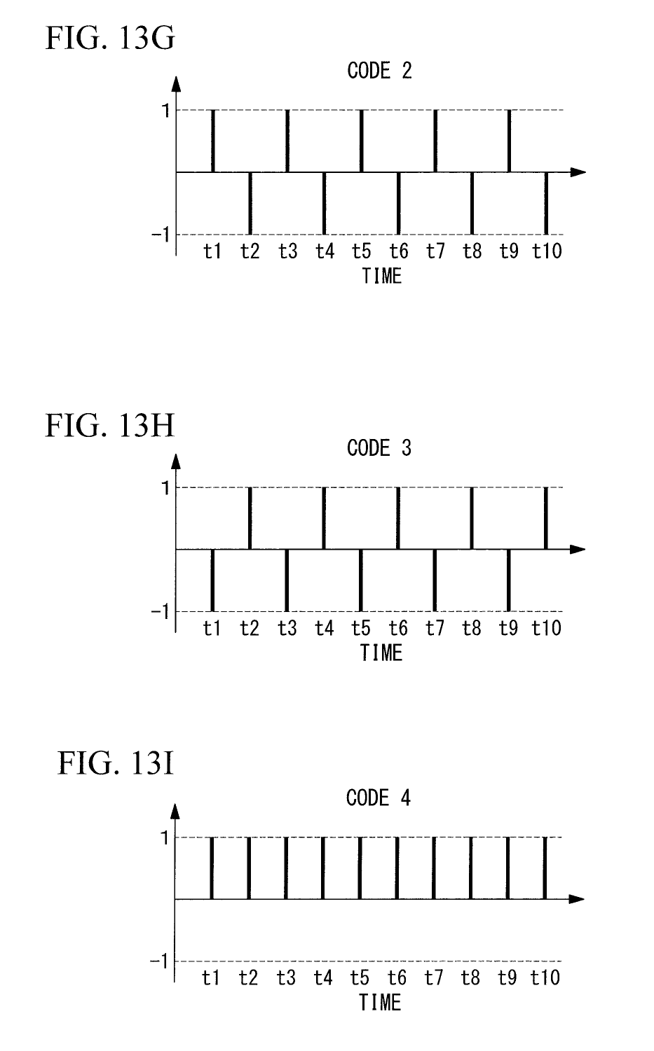

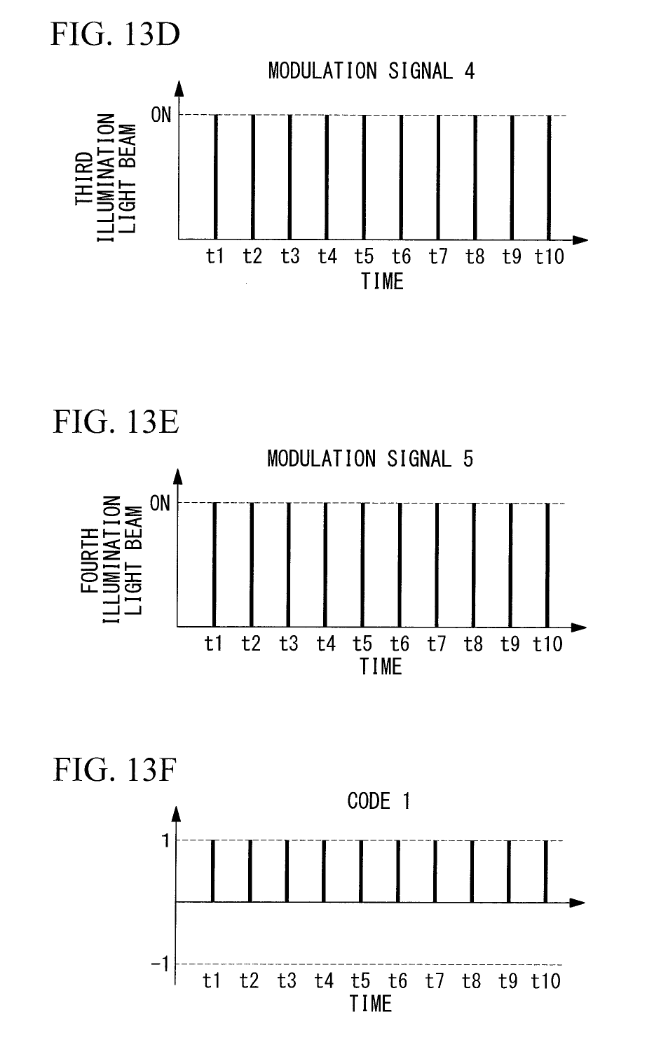

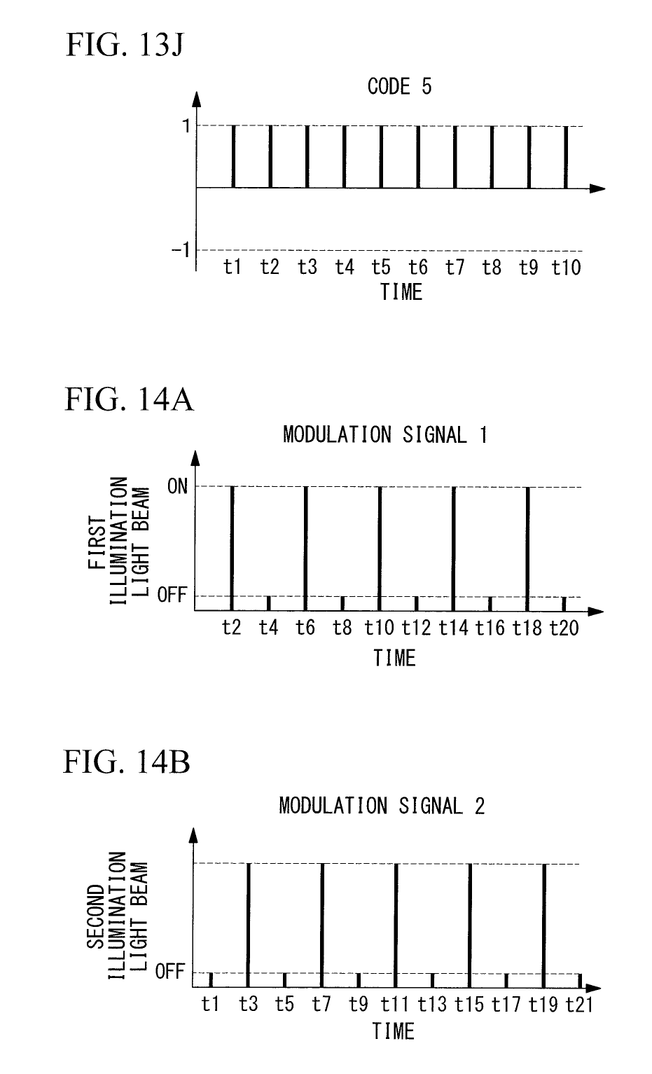

Specifically, as illustrated in FIGS. 13A and 13F, a light source 2 that emits pulsed laser light having a constant peak intensity at a frequency of 80 MHz is assumed as the light source 2.

When the light is modulated with a duty of 50% by the electro-optical modulator 8, two illumination light beams L1 and L2 are generated, consisting of a first illumination light beam L1 that is turned on and off at 40 MHz, as illustrated in FIGS. 13B and 13G, and a second illumination light beam L2 whose phase is inverted, as illustrated in FIGS. 13C and 13H.

On the other hand, third and fourth illumination light beams L3 and L4 that are turned on and off at a frequency of 80 MHz are generated, as illustrated in FIGS. 13D, 13E, 13I and 13J, by splitting light that passes along the light path not equipped with the electro-optical modulator 8 using the beam splitter 30.

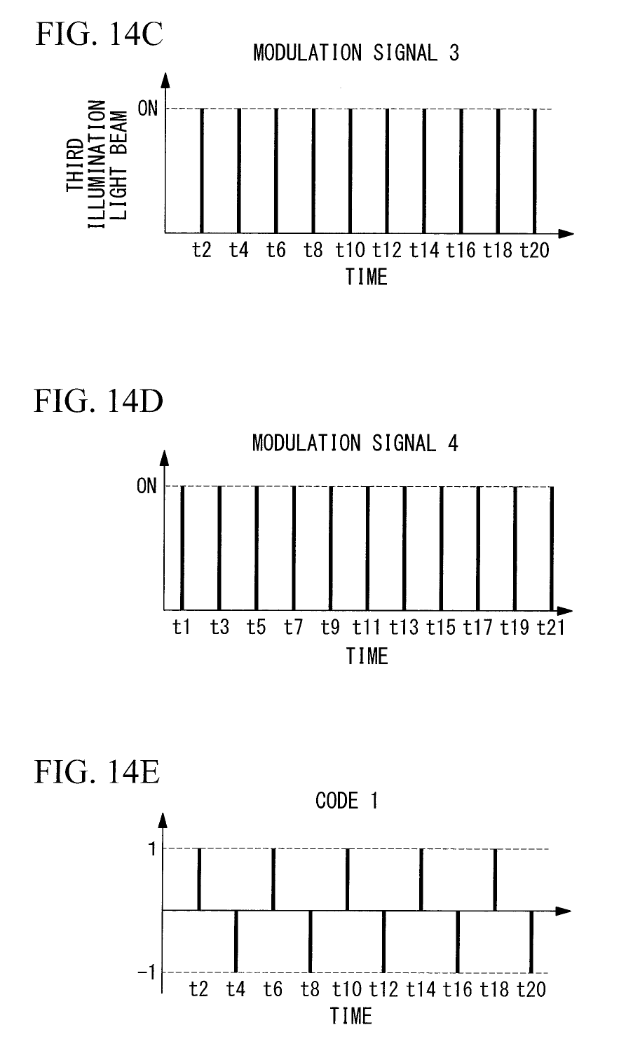

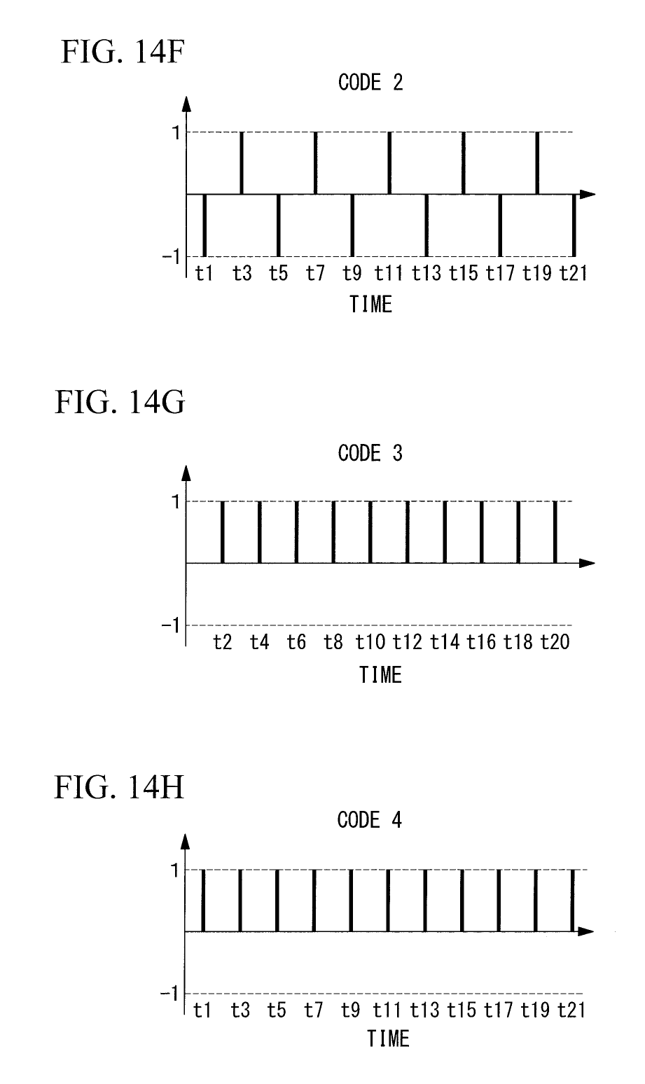

A pair of light beams consisting of the first illumination light beam L1 and the third illumination light beam L3, and a pair of light beams consisting of the second illumination light beam L2 and the fourth illumination light beam L4 are radiated onto the sample A at different timings, as illustrated in FIGS. 14A to 14H, by adjusting the optical path lengths of the second illumination light beam L2 and the fourth illumination light beam L4 so as to realize a time delay of 6.25 ns that is half the oscillation period of 12.5 ns of the laser light, and therefore fluorescence beams generated in accordance with the pair of illumination light beams L1 and L3 or the pair of illumination light beams L2 and L4 can be temporally separated from each other. Since the two pairs consisting of the illumination light beams L1 and L3 and the illumination light beams L2 and L4 have mutually linearly independent relationships, the beams can be demodulated in the same manner as described above.

With this configuration, there is an advantage in that a greater number of beams can be multiplexed by using a combination of the linear independence and temporal modulation of the illumination light beams L1 to L4, and a further improvement in frame rate can be achieved. Since light that is removed when modulation is performed by the electro-optical modulation unit 8 is also utilized, there is also an advantage that energy can be more efficiently utilized.

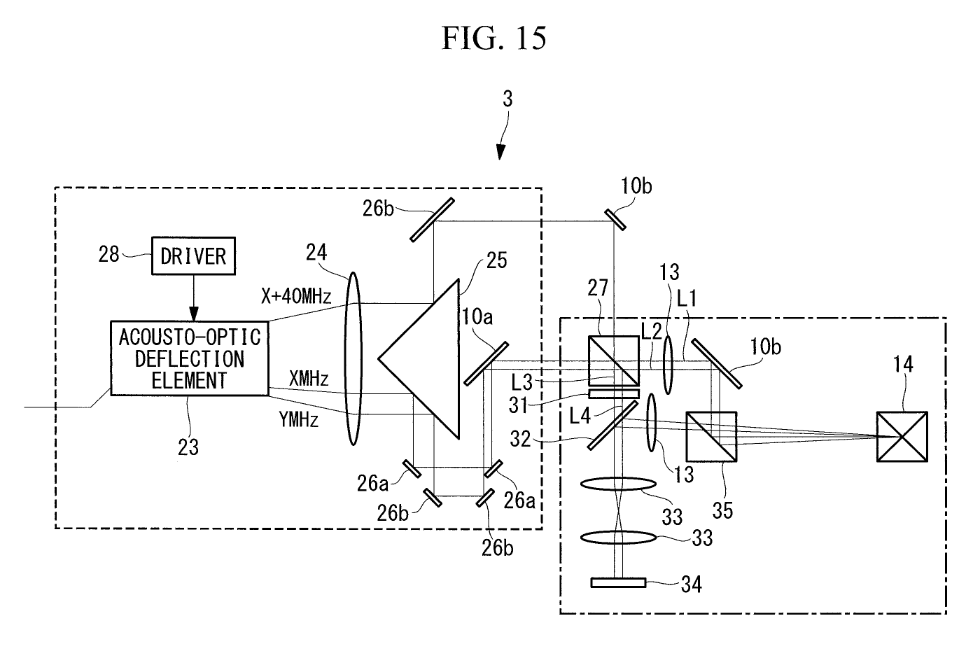

In addition, as illustrated in FIG. 15, in the image-obtaining device 1, which performs modulation using the acousto-optic deflection element 23 illustrated in FIG. 10, light that is removed when illumination light beams are combined using the beam splitter 27 may be delayed by being guided to a delay light path and may be temporally multiplexed. In the figure, reference sign 31 denotes a λ/2 plate, reference sign 32 denotes a mirror, reference sign 33 denotes a relay lens, and reference sign 34 denotes a reflecting mirror. The mirror 32 is offset from the light path of light that has passed through the λ/2 plate 31, and is arranged at a position so as to reflect only light that has been reflected by the reflecting mirror 34.

Similarly to as in FIG. 10, a light beam of X+40 MHz reflected by the beam splitter 27 and a light beam of X MHz that passed through the beam splitter 27 are combined with each other, and become an illumination light beam L1 of 40 MHz, and the illumination light beam L1 of 40 MHz and an illumination light beam L2 of Y=80 MHz that passed through the beam splitter 27 are reflected by a polarizing beam splitter 35.

The light of X+40 MHz that was not reflected by and passed through the beam splitter 27 and the light of X MHz that did not pass through and was reflected by the beam splitter 27 are combined with each other, and as a result, form an illumination light beam L3 of 40 MHz, and the illumination light beam L3 is incident on a delay light path. In the delay light path, the polarization direction of light is changed by the λ/2 plate 31, the light is deflected by the mirror 32 while returning via the relay lenses 33 and the reflecting mirror 34, and the light is made to pass through the polarizing beam splitter 35.

On the other hand, an illumination light beam L4 of Y=80 MHz that did not pass through and was reflected by the beam splitter 27 has the polarization direction thereof changed by the λ/2 plate 31, is deflected by the mirror 32 while returning via the relay lenses 33 and the reflecting mirror 34, and is made to pass through the polarizing beam splitter 35.

Thus, the pair of light beams consisting of the illumination light beam L1 of 40 MHz and the illumination light beam L2 of 80 MHz, which are mutually linearly independent of each other, and the pair of light beams consisting of the illumination light beam L3 of 40 MHz and the illumination light beam L4 of 80 MHz, which are mutually linearly independent of each other, are radiated onto different positions on the sample A at different timings. Thus, there is an advantage in that multiplexing of a greater number of beams can be performed by using a combination of the linear independence and temporal modulation of the illumination light beams L1 to L4, and a further improvement in frame rate can be achieved. Since the light that is removed by the beam splitter 27 is also utilized, there is also an advantage that energy can be more efficiently utilized.

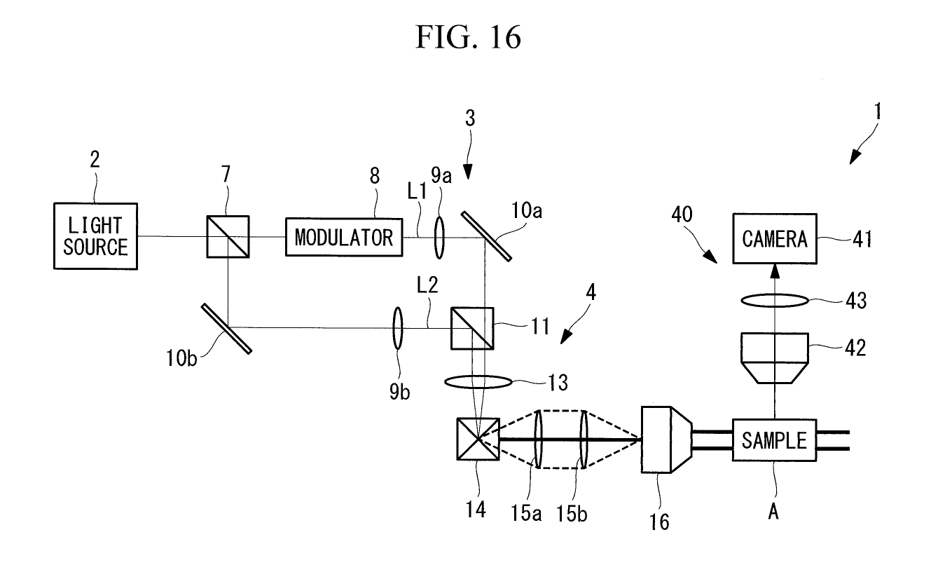

Furthermore, although a vertical-illumination-type image-obtaining device 1 is described in the above-described embodiments, the present invention is not limited thereto. For example, as illustrated in FIG. 16, the present invention may be applied to a light sheet microscope 40 in which sheet-shaped illumination light beams L1 and L2 having mutually linearly independent patterns are simultaneously made incident on positions that are spaced apart from each other in a direction that extends along the optical axis of the objective lens 16 from a direction orthogonal to the optical axis of the objective lens 16. {0058}

In the example illustrated in FIG. 16, the illumination light beams L1 and L2 are generated to have a pseudo-sheet shape by switching the intensity of one illumination light beam L1 or L2 every one frame of a camera 41 and scanning the light beams in two planes that are separated from each other in a direction that extends along the optical axis of the objective lens 16. Two fluorescence images corresponding to respective irradiation positions can be demodulated and obtained by collecting light beams from the sample A at the respective scanning positions using a microscope lens 42 and an image-forming lens 43, obtaining a plurality of images with the camera 41, for example, four images with every arrival of pulses in the case where four pulses arrive during the light exposure period and are duplexed, and computing an image obtained by utilizing the linear independence of the illumination light beams L1 and L2. In this case, phenomena that occur at different places at the same time can be simultaneously grasped.

In addition, sheet-shaped illumination light beams generated using a cylindrical lens may be employed instead of pseudo-sheet-shaped illumination light beams.

As a result, the above-described embodiment leads to the following aspects.

An aspect of the present invention provides an image-obtaining device that simultaneously illuminates a plurality of regions, and separates and obtains local signals corresponding to the illuminated regions, the image-obtaining device including: an illumination-light generating unit that modulates an intensity of light emitted from a light source, and generates a plurality of illumination light beams having mutually linearly independent patterns and including modulated illumination light, which has been modulated, and unmodulated illumination light, which has not been modulated; an illumination optical system that irradiates different positions on a sample with the plurality of illumination light beams generated by the illumination-light generating unit; a light-detecting unit that detects combined signal light resulting from combining signal light beams generated at a plurality of irradiation positions irradiated with the illumination light beams by the illumination optical system, and outputs a combined signal; and a demodulation unit that separates, from the combined signal output by the light-detecting unit, a modulated local signal corresponding to the modulated illumination light beam by using a time integral of a product of a demodulation signal corresponding to the modulated illumination light beam and the combined signal, and separates therefrom an unmodulated local signal corresponding to the unmodulated illumination light beam by subtracting a sum of the modulated local signals from a time integral of the combined signal.

According to this aspect, the illumination-light generating unit modulates the intensity of light emitted from the light source, and generates a plurality of illumination light beams that have mutually linearly independent patterns and include modulated illumination light, which has been modulated, and unmodulated illumination light, which has not been modulated, and the illumination optical system irradiates different positions on the sample with the plurality of generated illumination light beams. Signal light beams are simultaneously generated at the irradiation positions irradiated with the illumination light beams, and therefore, the light-detecting unit detects combined signal light consisting of a plurality of signal light beams generated at the plurality of irradiation positions and outputs a combined signal. Then, the output combined signal is input to the demodulation unit, and as a result, signal light beams generated at the respective irradiation positions are demodulated by separating, from the combined signal, a modulated local signal corresponding to the modulated illumination light beam by using the time integral of the product of the demodulation signal corresponding to the modulated illumination light beam and the combined signal, and separating an unmodulated local signal corresponding to the unmodulated illumination light beam by subtracting a sum of the modulated local signals from a time integral of the combined signal.

In this case, the signal light demodulation unit performs demodulation processing using demodulation signals that are synchronized with the patterns of the illumination light beams, and therefore, the individual signal light beams can be accurately extracted from the combined signal light by utilizing the mutual linear independence of the illumination light beams. Therefore, signal light beams that are caused to be simultaneously emitted from the plurality of irradiation positions can be accurately separated and detected, and the frame rate can be improved without the need for multiple devices corresponding to the number of times multiplexing is performed.

In the above-described aspect, a time integral of a product of the demodulation signal that does not correspond to the modulated illumination light beam, the modulated local signal that does not correspond to the modulated illumination light beam, and the unmodulated local signal may be zero.

In addition, in the above-described aspect, a time integral of a product of the demodulation signal corresponding to the unmodulated illumination light beam, and the combined signal may be a time integral of the combined signal.

Furthermore, in the above-described aspect, the image-obtaining device may further include a modulator that modulates an intensity of light along at least one light path of the plurality of illumination light beams generated by the illumination-light generating unit.

In addition, in the above-described aspect, two or more of the modulators may be provided, the modulators each generating the modulated illumination light beams having mutually orthogonal demodulation signals.

With this configuration, two or more illumination light beams having mutually orthogonal demodulation signals can be generated by a plurality of modulators, the signal strength obtained by using demodulation signals having orthogonality can be increased, and a further improvement in frame rate can be achieved.

Furthermore, in the above-described aspect, the image-obtaining device may have a function of arranging the plurality of irradiation positions at arbitrary positions within the sample.

In addition, another aspect of the present invention provides an image-obtaining method that includes: an illumination light generation step of modulating an intensity of light emitted from a light source, and generating a plurality of illumination light beams having mutually linearly independent patterns and including modulated illumination light, which has been modulated, and unmodulated illumination light, which has not been modulated; an irradiation step of irradiating different positions on a sample with the plurality of illumination light beams generated in the illumination light generation step; a light detection step of detecting combined signal light resulting from combining signal light beams generated at a plurality of irradiation positions irradiated with the illumination light beams in the irradiation step, and outputting a combined signal; and a signal light demodulation step of separating, from the combined signal output in the light detection step, a modulated local signal corresponding to the modulated illumination light beam by using a time integral of a product of a demodulation signal corresponding to the modulated illumination light beam and the combined signal, and separating therefrom an unmodulated local signal corresponding to the unmodulated illumination light beam by subtracting a sum of the modulated local signals from a time integral of the combined signal.

The present invention affords the advantage that a frame rate can be improved without the need for multiple devices corresponding to the number of times multiplexing is performed.

### REFERENCE SIGNS LIST

1 image-obtaining device

2 light source

3 illumination-light generating unit

4 illumination optical system

5 light-detecting unit

6 demodulation unit (signal light demodulation unit)

7, 7a, 7b first beam splitter (light-splitting unit)

8, 8a, 8b electro-optical modulator (modulator)

S1 illumination light generation step

S2 irradiation step

S3 light detection step

S4 fluorescence demodulation step (signal light demodulation step)

L1, L2, L2a, L2b, L3, L4 main light beams of illumination light

A sample

1. An image-obtaining device that simultaneously illuminates a plurality of regions, and separates and obtains local signals corresponding to the illuminated regions, the image-obtaining device comprising:
an illumination-light generating unit that modulates an intensity of light emitted from a light source and generates a plurality of illumination light beams having mutually linearly independent patterns and including modulated illumination light, which has been modulated, and unmodulated illumination light, which has not been modulated;
an illumination optical system that irradiates different positions on a sample with the plurality of illumination light beams generated by the illumination-light generating unit;
a light-detecting unit that detects combined signal light resulting from combining signal light beams generated at plurality of irradiation positions irradiated with the illumination light beams by the illumination optical system, and outputs a combined signal; and
a demodulation unit that separates, from the combined signal output by the light-detecting unit, a modulated local signal corresponding to the modulated illumination light beam by using a time integral of a product of a demodulation signal corresponding to the modulated illumination light beam and the combined signal, and separates an unmodulated local signal corresponding to the unmodulated illumination light beam by subtracting a sum of the modulated local signals from a time integral of the combined signal.

2. The image-obtaining device according to claim 1, wherein a time integral of a product of the demodulation signal that does not correspond to the modulated illumination light beam, the modulated local signal that does not correspond to the modulated illumination light beam, and the unmodulated local signal is zero.

3. The image-obtaining device according to claim 2, wherein a time integral of a product of the demodulation signal corresponding to the unmodulated illumination light beam and the combined signal is a time integral of the combined signal.

4. The image-obtaining device according to claim 1, further comprising:
a modulator that modulates an intensity of light along at least one light path of the plurality of illumination light beams generated by the illumination-light generating unit.

5. The image-obtaining device according to claim 4, wherein two or more of the modulators are provided, the modulators each generating the modulated illumination light beams, which have mutually orthogonal demodulation signals.

6. The image-obtaining device according to claim 1, wherein the image-obtaining device has a function of arranging the plurality of irradiation positions at arbitrary positions within the sample.

7. An image-obtaining method comprising:
an illumination-light generation step of modulating an intensity of light emitted from a light source and generating a plurality of illumination light beams having mutually linearly independent patterns and including modulated illumination light, which has been modulated, and unmodulated illumination light, which has not been modulated;
an irradiation step of irradiating different positions on a sample with the plurality of illumination light beams generated in the illumination-light generation step;
a light detection step of detecting combined signal light resulting from combining signal light beams generated at a plurality of irradiation positions irradiated with the illumination light beams in the irradiation step, and outputting a combined signal; and
a signal-light demodulation step of separating, from the combined signal output in the light detection step, a modulated local signal corresponding to the modulated illumination light beam by using a time integral of a product of a demodulation signal corresponding to the modulated illumination light beam and the combined signal, and separating an unmodulated local signal corresponding to the unmodulated illumination light beam by subtracting a sum of the modulated local signals from a time integral of the combined signal.
